(19) United States
(12) Patent Application Publication
(10) Pub. No.: US 2025/0174450 A1
(43) Pub. Date: May 29, 2025

(54) ALUMINOSILICATE GLASS WINDOWS WITH METAL FRAME

(71) Applicant: lonQ, Inc., College Park, MD (US)

(72) Inventor: Alexander Martyn KATO, Seattle, WA (US)

(21) Appl. No.: 18/960,966

(22) Filed: Nov. 26, 2024

Related U.S. Application Data
(60) Provisional application No. 63/603,461, filed on Nov. 28, 2023.

(51) Int. Cl. H01J 49/42; G06N 10/40

(52) U.S. Cl. CPC H01J 49/4255; G06N 10/40

(57) ABSTRACT

Aspects of the present disclosure relate generally to systems and methods for use in the implementation and/or operation of quantum information processing (QIP) systems, and more particularly, to an optical viewport for use with a vacuum housing that includes a glass portion including an aluminosilicate glass (ASG) material directly bonded to a metal frame.

### CROSS REFERENCE TO RELATED APPLICATIONS

The current application claims priority to U.S. Provisional Patent Application No. 63/603,461, filed Nov. 28, 2023, the entire contents of which are hereby incorporated by reference.

### TECHNICAL FIELD

Aspects of the present disclosure relate generally to systems and methods for use in the implementation, operation, and/or use of quantum information processing (QIP) systems.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, control, and/or functionality of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of optical windows including aluminosilicate glass and having metal frames that are configured as viewports for a vacuum chamber.

In some aspects, a quantum information processing (QIP) system includes a vacuum housing defining a chamber, an ion trap positioned within the chamber, and at least one optical viewport coupled to the vacuum housing and configured to provide optical access to the chamber. The at least one optical viewport including a glass portion including an aluminosilicate glass (ASG) material and a metal frame.

In some aspects, an optical viewport for use with a vacuum housing. The optical viewport includes a glass portion including an aluminosilicate glass (ASG) material directly bonded to a metal frame.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates an example QIP system in accordance with aspects of this disclosure.

FIG. 5 illustrates a top section view of a portion of the QIP system of FIG. 4 indicated by the arrows 5-5 in accordance with aspects of this disclosure.

FIG. 6 illustrates a perspective view of an example viewport of the QIP system of FIG. 4 in accordance with aspects of this disclosure.

FIG. 7 illustrates a section view of the viewport of FIG. 6 taken along lines A-A of FIG. 6 in accordance with aspects of this disclosure.

FIG. 8 illustrates a detail view of the viewport FIG. 6 of the region indicated by the arrow B in FIG. 7.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well known components.

In room-temperature quantum information processing (QIP) systems, an ion trap including a chain of trapped ions is positioned within a vacuum chamber that is maintained under high vacuum (UHV) conditions. These UHV conditions isolate the trapped ions from collisions with other gasses. Such collisions can disturb the trapped ions, reducing the useful lifespan of the chain of trapped ions.

The vacuum chambers of QIP systems include optical viewports which allow optical beams to access the trapped ions to enable quantum logic operations and laser cooling. However, in conventional QIP systems, these optical viewports are made of types of glass are permeable to helium, for example borosilicate or fused silica glass. In QIP systems that use a cryostat to cool the vacuum chamber to cryogenic temperatures, this helium permeability is a minor issue because the cryogenic temperatures of the vacuum chamber prevent the helium atoms from interacting with the chain of trapped ions. In contrast, in room-temperature QIP systems, the vacuum chamber is not cooled by a cryostat. Under room temperature conditions, helium atoms can build up over time, which can make it harder to maintain UHV conditions or extreme high vacuum (XHV) conditions over time. This can lead to a reduction in the lifetime of the trapped ion chain, which in turn can result in reduced performance of the QIP system. For example, such helium atoms may collide with the trapped ions, which can cause errors in in the system.

In some aspects, optical viewports made of sapphire have been used to reduce helium permeation. However, sapphire is a crystalline material and is birefringent. Different polarizations of light react differently to birefringent materials, for example because different polarizations of light (e.g., ordinary and extraordinary rays) experience different refraction indices in the birefringent material. This can cause the light rays to converge in different locations, resulting in separate foci. Since light may only be collected from one foci efficiently, and since the ions emit approximately 50% of each polarization, the amount of light collected can be reduced by approximately 50% for configurations in which optical viewports are made of birefringent materials.

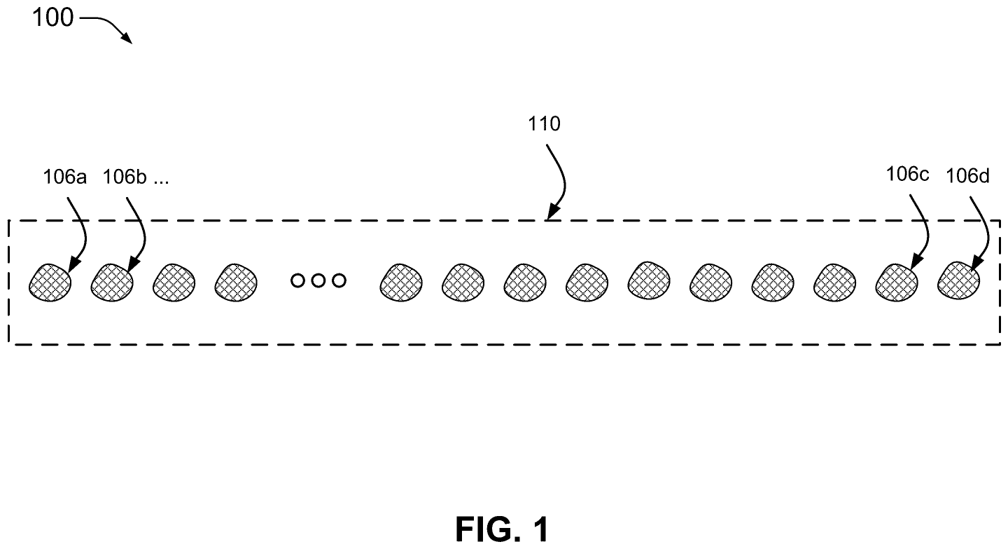

Solutions to the issues described above are explained in more detail in connection with FIGS. 1-8, with FIGS. 1-3 providing an exemplary QIP system or quantum computer, and more specifically, a general block diagram of an atomic-based QIP system or quantum computer according to an exemplary aspect.

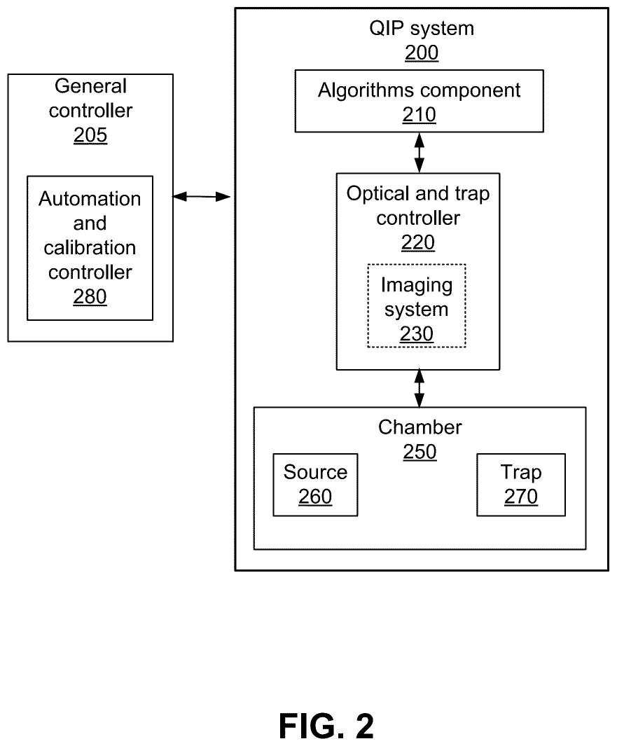

FIG. 1 illustrates a diagram 100 with multiple atomic ions or ions 106 (e.g., ions 106a, 106b, . . . , 106c, and 106d) trapped in a linear crystal or chain 110 using a trap (not shown; the trap can be inside a vacuum chamber as shown in FIG. 2). The trap may be referred to as an ion trap. The ion trap shown may be built or fabricated on a semiconductor substrate, a dielectric substrate, or a glass die or wafer (also referred to as a glass substrate). The ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple ions into the chain 110 laser-cooled to be nearly at rest. The number of ions trapped can be configurable and more or fewer ions may be trapped. The ions can be Ytterbium ions (e.g., ¹⁷¹Yb⁺ ions), for example. The ions are illuminated with laser (optical) radiation tuned to a resonance in ¹⁷¹Yb⁺ and the fluorescence of the ions is imaged onto a camera or some other type of detection device (e.g., photomultiplier tube or PMT). In this example, ions may be separated by a few microns (m) from each other, although the separation may vary based on architectural configuration. The separation of the ions is determined by a balance between the external confinement force and Coulomb repulsion and does not need to be uniform. Moreover, in addition to Ytterbium ions, neutral atoms, Rydberg atoms, or other types of atomic-based qubit technologies may also be used. Moreover, ions of the same species, ions of different species, and/or different isotopes of ions may be used. The trap may be a linear RF Paul trap, but other types of confinement devices may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 illustrates a block diagram that shows an example of a QIP system 200. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations. The quantum and classical computations and operations may interact in such a hybrid system.

Shown in FIG. 2 is a general controller 205 configured to perform various control operations of the QIP system 200. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include the algorithms component 210 mentioned above, which may operate with other parts of the QIP system 200 to perform or implement quantum algorithms, quantum applications, or quantum operations. The algorithms component 210 may be used to perform or implement a stack or sequence of combinations of single qubit operations and/or multi-qubit operations (e.g., two-qubit operations) as well as extended quantum computations. The algorithms component 210 may also include software tools (e.g., compilers) that facilitate such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include the optical and trap controller 220 mentioned above, which controls various aspects of a trap 270 in the chamber 250, including the generation of signals to control the trap 270. The optical and trap controller 220 may also control the operation of lasers, optical systems, and optical components that are used to provide the optical beams that interact with the atoms or ions in the trap. Optical systems that include multiple components may be referred to as optical assemblies. The optical beams are used to set up the ions, to perform or implement quantum algorithms, quantum applications, or quantum operations with the ions, and to read results from the ions. Control of the operations of laser, optical systems, and optical components may include dynamically changing operational parameters and/or configurations, including controlling positioning using motorized mounts or holders. When used to confine or trap ions, the trap 270 may be referred to as an ion trap. The trap 270, however, may also be used to trap neutral atoms, Rydberg atoms, and other types of atomic-based qubits. The lasers, optical systems, and optical components can be at least partially located in the optical and trap controller 220, an imaging system 230, and/or in the chamber 250. The QIP system 200 may include the imaging system 230. The imaging system 230 may include a high-resolution imager (e.g., CCD camera) or other type of detection device (e.g., PMT) for monitoring the ions while they are being provided to the trap 270 and/or after they have been provided to the trap 270 (e.g., to read results). In an aspect, the imaging system 230 can be implemented separate from the optical and trap controller 220, however, the use of fluorescence to detect, identify, and label ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of what may be referred to as a processor or processing portion of the QIP system 200. That is, the trap 270 may be considered at the core of the processing operations of the QIP system 200 since it holds the atomic-based qubits that are used to perform or implement the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure. Moreover, aspects of this disclosure may be implemented at least partially using the trap 270 and the chamber 250.

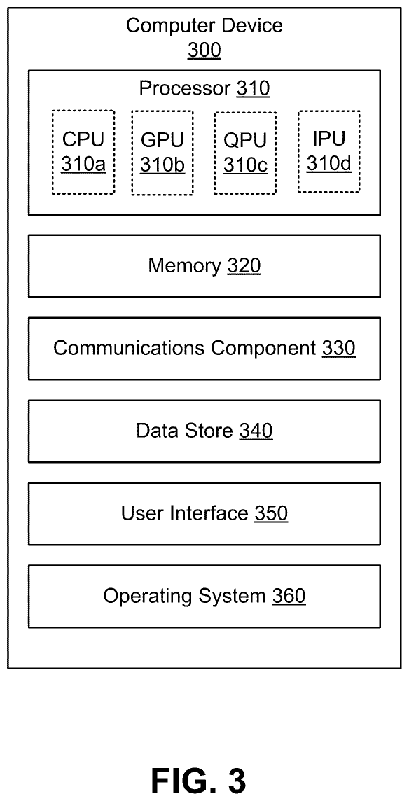

Referring now to FIG. 3, an example of a computer system or device 300 is shown. The computer device 300 may represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single processor, multiple set of processors, or one or more multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300). Quantum operations may be performed by the QPUs 310c. Some or all of the QPUs 310c may use atomic-based qubits, however, it is possible that different QPUs are based on different qubit technologies.

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300. Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300. In connection with the systems described in FIGS. 1-3, the aspects disclosed herein provide viewports that are structurally configured to be used in a vacuum chamber (e.g., chamber 250 of FIG. 2) and that have reduced permeability to helium.

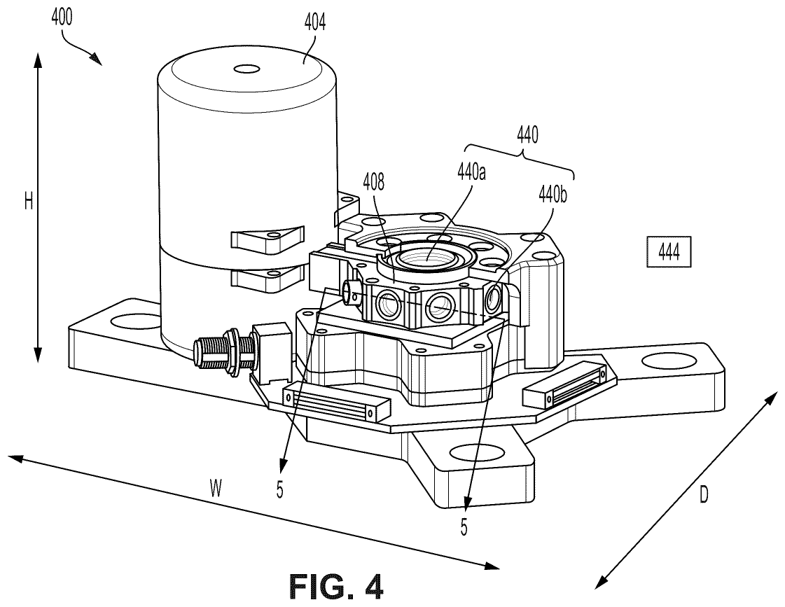

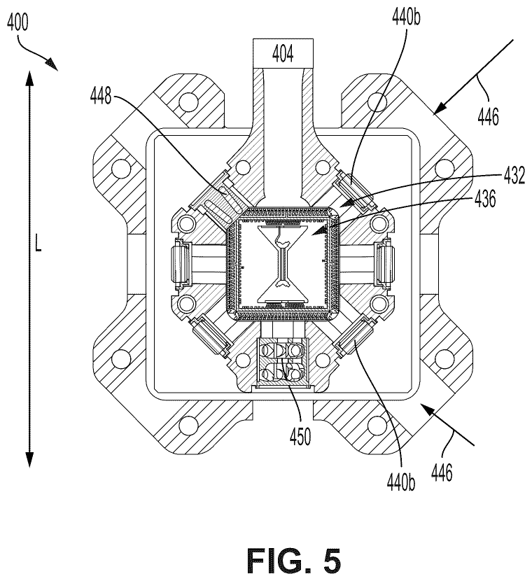

FIG. 4 illustrates an example room-temperature QIP system 400. FIG. 5 illustrates a top section view of a portion of the QIP system 400 indicated by the arrows 5-5. The QIP system 400 includes an ion pump 404 and a vacuum housing 408. In an example aspect, the QIP system 400 is a compact QIP system and has a height H of approximately 69 millimeters (mm), a width W of approximately 133 mm, and a depth D of approximately 97 mm. In other aspects, the QIP system 400 may have other dimensions.

In the example QIP system 400, the vacuum housing 408 defines the chamber 432 (FIG. 5), which may be similar to (or correspond to) the chamber 250. As shown in FIG. 5, an ion trap 436, which may be similar to (or correspond to) the ion trap 270, is positioned within the chamber 432. The ion pump 404 may be coupled to the ion trap 436 and is configured to provide ions to the ion trap 436. In an example aspect, the ion trap 436 may have a length L (FIG. 5) of approximately 50 mm. In other aspects, the ion trap 436 may have a different length.

One or more optical viewports are coupled to the vacuum housing 408 to provide optical access to the chamber 432. Optical access to the chamber 436 allows qubits to be created and maintained (e.g., by trapping atoms or ions). Optical access to the chamber 432 allows addressing the qubits in the ion trap 436 and reading out light emitted by the qubits in the ion trap 436. Optical access to the chamber 432 also allows laser cooling of the qubits in the ion trap 436.

In some aspects, a first optical viewport 440a may be positioned in an upper portion of the vacuum housing 408. Second optical viewports 440b may be positioned about a perimeter of the vacuum housing 408. The optical viewports 440 allow laser beams from laser sources 444 positioned outside of the vacuum housing 408 to cool and/or conduct qubit operations with the trapped ions in the ion trap 436. For example, arrows 446 show schematic representations of laser beams configured to enter the chamber 432 via the optical viewports 440b and interact with the trapped ions in the ion trap 436. As described in greater detail below, the optical viewports 440 are welded to the vacuum housing 408 in a fluid-tight connection. In the example aspect illustrated in FIG. 4, the first optical viewport 440a may be used for imaging the trapped ions in the ion trap 436. This is typically an application that uses a high numerical aperture (NA) imaging objective configured to collect light emitted from trapped ions at large angles relative to the imaging objective. Such applications need optical viewports 440a including a non-birefringent material to operate effectively. In the example illustrated in FIG. 4, the side optical viewports 440b may be used for loading ions into the ion trap 436 and/or cooling the ions in the ion trap 436. The laser beams used for loading, detecting and/or cooling the trapped ions are typically low NA beams, so in some aspects, birefringent materials can be used for optical viewports. However, in some applications, the optical viewports 440b may be used for applications involving Raman beams. Such applications need optical viewports 440b including a non-birefringent material to operate effectively.

The vacuum housing 408 may also include pockets 448 for atomic sources and a getter 450. The pockets 448 include the source material for the ions that are loaded into the ion trap 436. The getter 450 is configured to pump residual gases out of the chamber 432. During operation of the QIP system 400, the chamber 432 is maintained under ultra-high vacuum (UHV) or extreme-high vacuum (XHV) conditions.

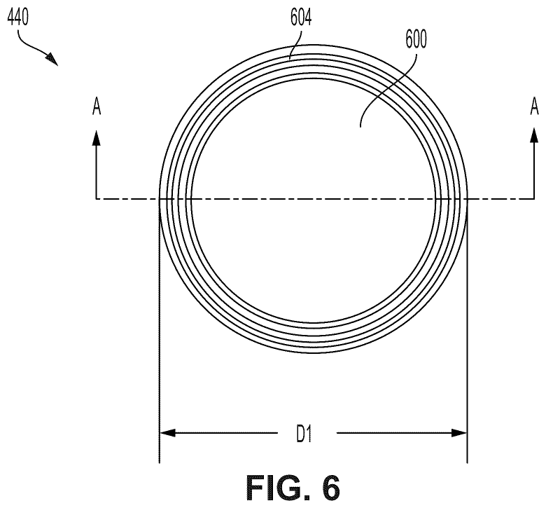

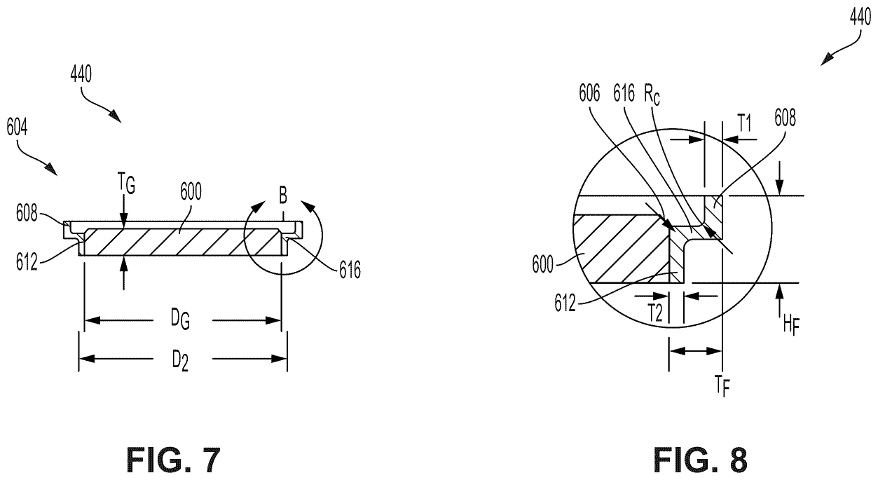

FIG. 6 illustrates a perspective view of one of the optical viewports 440. FIG. 7 illustrates a section view of the optical viewport 440 taken along lines A-A of FIG. 6. FIG. 8 illustrates a detail view of the optical viewport 440 of the region indicated by the arrow B.

The optical viewport 440 includes a glass portion 600 and a metal frame 604. In an exemplary aspect, the glass portion 600 is made of an aluminosilicate glass (ASG) material. Since glass has an amorphous structure, the ASG material is non-birefringent. The permeability of helium through the glass portion 600 is a related to the composition of the glass portion 600. As the weight content of non-glass material, such as alumina (Al₂O₃), in the glass portion 600 increases, the permeation rate of helium through the glass portion 600 decreases. For example, in some aspects, the ASG material includes approximately 15% alumina content by weight. In such aspects, the rate of permeation of helium through the glass portion is three times slower than the rate of permeation of helium through glass that does not include alumina. In some aspects, the ASG material includes at least 15% alumina content by weight. In the example aspect shown in FIGS. 7-8, a diameter DG of the glass portion 600 is approximately 0.591 inches (in) and a thickness TG of the glass portion 600 is approximately 0.079 in. In some aspects, an edge 606 of the glass portion is chamfered for 0.02 inches and an angle of 45°. In other aspects, the diameter DG pf the glass portion 600, the thickness TG of the glass portion, and/or the edge 606 may have different dimensions.

The glass portion 600 may be bonded to the metal frame 604 via brazing, glass soldering, glass frit bonding, or otherwise hermetically sealing the glass portion 600 to the metal frame 604 to form the viewports 440. Therefore, in some aspects, each of the viewports 440 includes the glass portion 600 directly bonded to the metal frame 604 in hermetic seal. In some aspects, the glass portion 600 may be bonded to the metal frame 604 by an intermediate material, such as for example, braze material or glass frit material. Such material would directly weld to the glass material and to the titanium, forming a seal. It is noted that the technique is different from anodic bonding where two materials are joined together without any intermediate material.

After the glass portion 600 has been bonded to the metal frame 604, the metal frame 604 may be welded into the vacuum housing 408 in a hermetic seal. Bonding the glass portion 600 directly to the metal frame 604 allows the optical viewports 440 to be used in situations where anodic bonding may be unfeasible or undesirable, because the metal frame 604 can be welded to vacuum housing 408. Such a configuration provides a vacuum housing 408 having non-birefringent optical viewports 440 that are resistant to helium permeation and hermetically sealed to the vacuum housing 408. Further, the metal frame 604 allows the optical viewports 440 to be coupled to other metal components used in vacuum systems, such as pumps and/or gauges.

The metal frame 604 may be made of a titanium, kovar, stainless steel, or alumina material. In some aspects, the material of the metal frame 604 may be determined based on the material of the vacuum housing 408. For example, in aspects in which the vacuum chamber 408 includes a titanium material, the metal frame 604 may include a titanium material. In aspects in which the vacuum chamber 408 includes a stainless steel material, the metal frame 604 may include a material such as kovar.

The metal frame includes a first portion 608 having a first diameter D1 (FIG. 6), a second portion 612 having a second diameter D2, and a stepped portion 616 connecting the first portion 608 and the second portion 612. The first diameter D1 is wider than the second diameter D2. As shown in FIGS. 7-8, the glass portion 600 is bonded to an inner surface of the second portion 612 of the metal frame 604. In aspects in which the edge 606 of the glass portion 600 is chamfered, the chamfer edge 606 is proximate the stepped portion 616. An outer surface of the metal frame 604 may be hermetically welded to the vacuum housing 408.

In the example aspect shown in FIGS. 7-8, the optical viewports 440 have a circular shape. However, in other aspects, the optical viewports may have a different shape other than a circular viewport, such as an oval shape, an elliptical shape, a racetrack-type shape, and so forth.

In the example aspects shown in FIGS. 7-8, the diameter D1 (FIG. 6) of the first portion is approximately 0.714 in. In some aspects, a thickness T1 of the first section is approximately 0.2 in. In some aspects, the diameter D2 of the second portion is approximately 0.594 in. In some aspects, a thickness T2 of the second portion is approximately 0.015 in. In some aspects, a thickness TF of the metal frame 604 is 0.6 in. In some aspects, a radius of curvature Rc between the first portion 608 and the stepped portion 616 is approximately 0.01. In some aspects, a height HF of the metal frame 604 is approximately 0.1 in. In other aspects, the diameter D1, the thickness T1, the diameter D2, the thickness T2, the thickness TF of the metal frame, the height HF of the metal frame, and/or the radius of curvature Re may have different dimensions.

In some aspects, the metal frame 604 is made of a titanium material. In some aspects, the metal frame 604 may have a coefficient of thermal expansion that is similar to a coefficient of thermal expansion of the glass portion 600.

In some aspects, the optical viewports 440 may be used in room temperature vacuum systems having very low ultimate pressures (such as, for example XHV conditions) where optical access to the chamber 432 is required and where birefringent materials cannot be used. The optical viewports 440 may be used in systems in which metal housing components are needed and/or anodic bonding cannot be used.

In contrast, in conventional systems, ASG materials are not directly bonded or fused to metal frames. Instead, ASG materials are conventionally directly bound to silicon or other types of glass via optical contact bonding or anodic bonding in configurations in which metal is not directly bonded to the ASG material. In such configurations, the ASG materials cannot be welded or otherwise hermetically sealed into metal housings.

In some aspects, the optical viewports 440 are advantageous in applications in which the laser beams enter the optical viewport 440 at a high numerical aperture or when the laser beam is a Raman beam. For example, the high numerical aperture and/or Raman beams used for qubit operations are focused very tightly to interact with a desired ion in the ion trap 436. Such beams enter the optical viewport 440 at steep angles. In conditions in which a conventional viewport made of a birefringent material is used, the birefringence of the viewport can cause shifting of the high numerical aperture and/or Raman beams, which may cause the high numerical aperture and/or Raman beams to interact with the trapped ions differently than intended. In contrast, the optical viewports 440 of the present disclosure are made of an ASG material, which is not birefringent. Therefore, high numerical aperture and/or Raman beams passing through the optical viewports 440 of the present disclosure are not shifted, and contact the trapped ions as intended.

In some aspects, the first optical viewport 440a may receive addressing beams including high numerical aperture and/or Raman beams. In such aspects, the glass portion 600 of the first optical viewport 440a includes the ASG material. In some aspects, the second optical viewports 440b may receive Raman beams, which have high NAs. In such aspects the second optical viewports 440b may also include ASG material. In other aspects, the second optical viewports 440b may receive small numerical aperture NA used for applications such as cooling, detection beams, and loading beams. Since these beams have small NAs, the difference in focal point between ordinary and extraordinary rays will not deviate significantly, so in such aspects, second optical viewports including birefringent materials may be used.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed:

1. A quantum information processing (QIP) system comprising:
a vacuum housing defining a chamber;
an ion trap positioned within the chamber; and
at least one optical viewport coupled to the vacuum housing and configured to provide optical access to the chamber, the at least one optical viewport including a glass portion including an aluminosilicate glass (ASG) material and a metal frame.

2. The QIP system of claim 1, wherein the ASG material includes approximately 15% alumina by weight.

3. The optical viewport of claim 2, wherein the ASG material includes at least 15% alumina by weight.

4. The QIP system of claim 1, wherein the ASG material is directly bonded to the metal frame in a hermetic seal.

5. The QIP system of claim 4, wherein the metal frame is welded to the vacuum housing in a hermetic seal.

6. The QIP system of claim 1, wherein the QIP system is operable at room temperature.

7. The QIP system of claim 1, wherein the metal frame includes at least one of titanium, stainless steel, or kovar.

8. An optical viewport for use with a vacuum housing, the optical viewport comprising:
a glass portion including an aluminosilicate glass (ASG) material bonded to a metal frame.

9. The optical viewport of claim 8, wherein the ASG material includes approximately 15% alumina by weight.

10. The optical viewport of claim 8, wherein the ASG material includes at least 15% alumina by weight.

11. The optical viewport of claim 8, wherein the ASG material is directly bonded to the metal frame in a hermetic seal.

12. The optical viewport system of claim 11, wherein the metal frame is welded to the vacuum housing in a hermetic seal.

13. The optical viewport of claim 8, wherein the QIP system is operable at room temperature.

14. The optical viewport of claim 8, wherein the metal frame includes at least one of titanium, stainless steel, or kovar.
